(19) United States
(12) Patent Application Publication
(10) Pub. No.: US 2026/0084242 A1
(43) Pub. Date: Mar. 26, 2026

(54) WELDING METHOD AND WELDING STRUCTURE

(71) Applicant: Prime Planet Energy & Solutions, Inc., Tokyo (JP)

(72) Inventors: Tomomi TANAKA, Osaka (JP); Katsuaki ISHITANI, Kasai-shi (JP)

(21) Appl. No.: 19/324,123

(22) Filed: Sep. 10, 2025

(30) Foreign Application Priority Data
Sep. 25, 2024 (JP) 2024-165982

(51) Int. Cl. B23K 26/323; B23K 26/26

(52) U.S. Cl. CPC B23K 26/323; B23K 26/26

(57) ABSTRACT

In a welding method of the present disclosure, a first metal layer and a second metal layer are made of a first metal material of an identical kind, a third metal layer is made of a second metal material different from the first metal material, and when irradiation and scanning with laser light are performed from a side of the first metal layer to join the first metal layer and the second metal layer together by laser welding, the scanning with the laser light includes a first scanning step and a second scanning step after the first scanning step, the first scanning step includes a step of causing the second metal layer to be penetrated through by the irradiation with the laser light, and the second scanning step includes a step of not causing the second metal layer to be penetrated through by the irradiation with the laser light.

### CROSS REFERENCE TO RELATED APPLICATIONS

This nonprovisional application is based on Japanese Patent Application No. 2024-165982 filed on Sep. 25, 2024 with the Japan Patent Office, the entire contents of which are hereby incorporated by reference.

### BACKGROUND OF THE INVENTION

### Field of the Invention

The present disclosure relates to a welding method and a welding structure.

### Description of the Background Art

Japanese Patent Laying-Open No. 2003-094184 discloses a welding method to reduce explosion of molten metal and occurrence of a weld defect. Specifically, explosion of molten metal and occurrence of a weld defect are reduced by, after preheating with preceding first laser light, performing main welding with subsequent second laser light.

### SUMMARY OF THE INVENTION

In a battery assembly, a bus bar is fixed to an electrode terminal provided on a battery cell by welding. As the electrode terminal, a terminal having a two-layer structure is used, in which aluminum is used for the upper layer so as to gain favorable welding to the bus bar for which aluminum is used and copper is used for the lower layer so as to gain favorable connection with a battery element in the battery cell.

As described above, when a bus bar is welded to an electrode terminal having a two-layer structure, the bus bar is welded to the aluminum of the upper layer. In the welding, air present in a gap between the upper layer and the lower layer of the electrode terminal is heated by the heat of laser light used for the welding and is thermally expanded accordingly. Further, an organic substance present in the gap is similarly heated by the heat of the laser light used for the welding and is vaporized accordingly. As a result, the gap between the upper layer and the lower layer is filled with the expanded air and the vaporized gas.

If the operation of welding the bus bar to the electrode terminal is continued in this state, the expanded air and the vaporized gas may be ejected to the outside at the moment at which a molten pool formed in the welding reaches the region between the upper layer and the lower layer (the region filled with the gas), and the bus bar may fail to be favorably connected to the electrode terminal.

The present disclosure has been made so as to address the above-described problems and an object thereof is to provide a welding method and a welding structure that enable it to favorably weld a bus bar to an electrode terminal provided on a battery cell employed in a battery assembly.
[1] A welding method according to the present disclosure is a welding method of joining a first metal layer and a second metal layer together by laser welding, the first metal layer, the second metal layer, and a third metal layer being arranged in this order from an upper side, wherein the first metal layer and the second metal layer are made of a first metal material of an identical kind, the third metal layer is made of a second metal material different from the first metal material, and when irradiation and scanning with laser light are performed from a side of the first metal layer to join the first metal layer and the second metal layer together by the laser welding, the scanning with the laser light includes a first scanning step and a second scanning step after the first scanning step, the first scanning step includes a step of causing the second metal layer to be penetrated through by the irradiation with the laser light, and the second scanning step includes a step of not causing the second metal layer to be penetrated through by the irradiation with the laser light.
[2] The welding method according to [1], wherein an output of the laser light in the first scanning step is larger than an output of the laser light in the second scanning step.
[3] The welding method according to [1], wherein duration of the irradiation with the laser light in the first scanning step is longer than duration of the irradiation with the laser light in the second scanning step.
[4] The welding method according to any one of [1] to [3], wherein the first metal material is aluminum, and the second metal material is copper.
[5] The welding method according to any one of [1] to [4], wherein the first metal layer constitutes a bus bar used in a battery assembly, the second metal layer and the third metal layer constitute an electrode terminal included in the battery assembly, and the bus bar is welded to the electrode terminal using the laser light.
[6] A welding structure of the present disclosure is a welding structure comprising a first metal layer, a second metal layer, and a third metal layer arranged in this order from an upper side, the first metal layer and the second metal layer being joined together by laser welding, wherein the first metal layer and the second metal layer are made of a first metal material of an identical kind, the third metal layer is made of a second metal material different from the first metal material, irradiation and scanning with laser light are performed from a side of the first metal layer to join the first metal layer and the second metal layer together by the laser welding, and when viewed in cross-section along a direction of the irradiation with the laser light after the laser welding, a welding depth of a weld between the first metal layer and the second metal layer is smaller in a central portion than in an outer portion, and the welding depth in the outer portion is large so that the second metal layer is penetrated through.
[7] The welding structure according to [6], wherein the first metal material is aluminum, and the second metal material is copper.
[8] The welding structure according to any one of [6] and [7], wherein the first metal layer constitutes a bus bar used in a battery assembly, and the second metal layer and the third metal layer constitute an electrode terminal included in the battery assembly.

The foregoing and other objects, features, aspects, and advantages of the present disclosure will become apparent from the following detailed description on the present disclosure, which will be understood in conjunction with the accompanying drawings.

### BRIEF DESCRIPTION OF THE DRAWINGS

FIG. 1 is a diagram illustrating a basic configuration of a battery assembly.

FIG. 2 is a diagram illustrating battery cells and end plates in the battery assembly illustrated in FIG. 1.

FIG. 3 is a diagram illustrating the battery cell in the battery assembly illustrated in FIG. 1.

FIG. 4 is a diagram illustrating arrangement of bus bars in the battery assembly.

FIG. 5 is a partial cross-sectional view in the direction of arrow V in FIG. 4.

FIG. 6 is a first schematic view illustrating a method of welding an electrode terminal and the bus bar.

FIG. 7 is a second schematic view illustrating the method of welding the electrode terminal and the bus bar.

FIG. 8 is a first cross-sectional view according to related art, which corresponds to the direction of arrow V in FIG. 4.

FIG. 9 is a second cross-sectional view according to the related art, which corresponds to the direction of arrow V in FIG. 4.

### DESCRIPTION OF THE PREFERRED EMBODIMENTS

Embodiments of the present technology are described below. The same or corresponding portions are denoted by the same reference characters, and may not be described repeatedly.

In the embodiments described below, when reference is made to numbers, amounts, and the like, the scope of the present technology is not necessarily limited to the numbers, amounts, and the like unless otherwise stated particularly. In the embodiments described below, each component is not necessarily essential to the present technology unless otherwise stated particularly. The present technology is not necessarily limited to one that exhibits all the functions and effects mentioned in the embodiments disclosed herein.

In the present specification, the terms “comprise”, “include”, and “have” are open-end terms. That is, when a certain configuration is included, a configuration other than the foregoing configuration may be included or may not be included.

In the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing a relative positional relation such as “upper side” and “lower side” are used, these terms are used to indicate a relative positional relation in one state, and the relative positional relation may be reversed or turned at any angle in accordance with an installation direction of each mechanism (for example, the entire mechanism is reversed upside down).

A battery assembly 1, described below, can be mounted on a battery electric vehicle (BEV), a plug-in hybrid electric vehicle (PHEV), a hybrid electric vehicle (HEV), and the like. However, the application of battery assembly 1 is not limited to the use in a vehicle.

### Battery Assembly 1

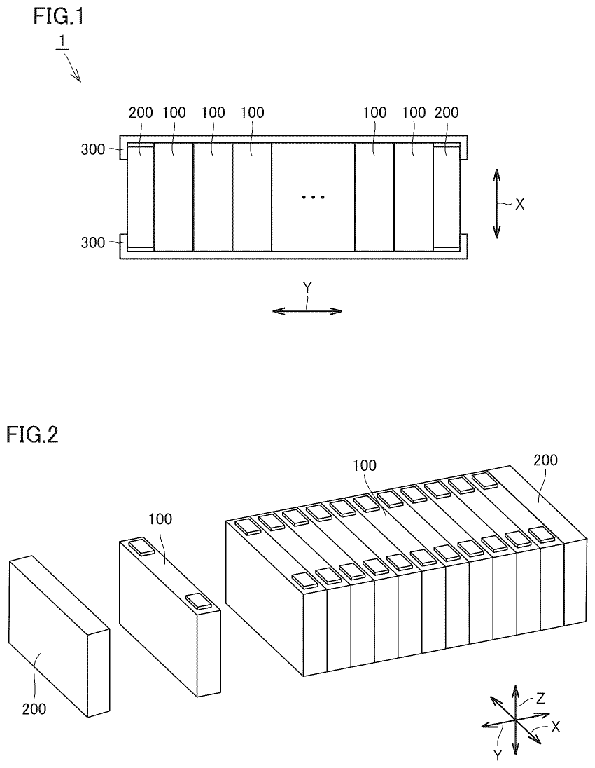

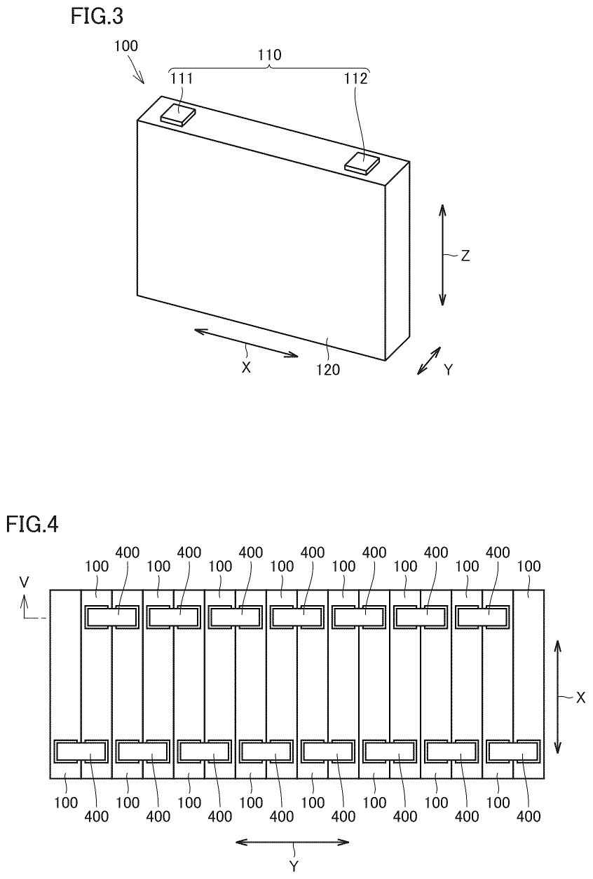

FIG. 1 is a diagram illustrating a basic configuration of battery assembly 1. FIG. 2 is a diagram illustrating battery cells 100 and end plates 200 included in battery assembly 1. FIG. 3 is a diagram illustrating battery cell 100 in battery assembly 1.

As illustrated in FIGS. 1 and 2, battery assembly 1 as an example of a “power storage module” includes battery cell 100, end plate 200, and a restraint member 300.

Although battery cell 100 as an example is a lithium ion battery, battery cell 100 may be another battery such as a nickel-metal hydride battery.

The plurality of battery cells 100 are arranged side by side in a Y axis direction (an arrangement direction). Battery cell 100 includes an electrode terminal 110. Separators (not illustrated) may be interposed between the plurality of battery cells 100. The plurality of battery cells 100 held between the two end plates 200 are pressed by end plates 200 and restrained between the two end plates 200.

End plates 200 are arranged at both ends of battery assembly 1 in the Y axis direction (arrangement direction). End plate 200 is fixed to a base such as a case that houses battery assembly 1.

Restraint member 300 connects the two end plates 200 to each other. Restraint member 300 is attached to the two end plates 200.

By causing restraint member 300 to engage with end plates 200 in a state where a compressive force in the Y axis direction acts on the stack of the plurality of battery cells 100 and end plates 200 and then releasing the compressive force, tension is exerted on restraint member 300 connecting the two end plates 200. In reaction thereto, restraint member 300 presses the two end plates 200 in a direction in which the two end plates 200 come nearer to each other.

As illustrated in FIG. 3, battery cell 100 is formed so as to have a rectangular parallelepiped shape with flat surfaces. Electrode terminal 110 includes a positive electrode terminal 111 and a negative electrode terminal 112. Electrode terminal 110 is formed on an upper surface of a housing 120 having a prismatic shape. An electrode assembly and an electrolyte solution, which are not illustrated, are accommodated in housing 120. For convenience in explaining the form of battery cell 100, in the description below, an X axis direction may be referred to as the width direction, the Y axis direction may be referred to as the thickness direction, and a Z axis direction may be referred to as the height direction.

FIG. 4 is a diagram illustrating arrangement of bus bars 400 in battery assembly 1. In the example of FIG. 4, positive electrode terminal 111 of battery cell 100 and negative electrode terminal 112 of battery cell 100 adjacent thereto are electrically connected by bus bar 400, and the plurality of battery cells 100 are electrically connected in series accordingly.

That is, battery assembly 1 includes the plurality of battery cells 100 that each include electrode terminal 110 and are arranged along a predetermined direction, and bus bar 400 that connects respective electrode terminals 110 of the plurality of battery cells 100 to each other.

### Welding Method and Welding Structure

A welding method and a welding structure of electrode terminal 110 and bus bar 400 are described next with reference to FIGS. 5 to 7. As an example, a case where negative electrode terminal 112 of electrode terminal 110 and bus bar 400 are welded to each other is described.

Bus bar 400 (a first metal layer) is made of aluminum. Negative electrode terminal 112 includes a first electrode member 112a, which is connected to a battery element (not illustrated) provided in battery cell 100, and a second electrode member 112b, which is provided so as to cover first electrode member 112a and be integrated with first electrode member 112a. Second electrode member 112b (a second metal layer) is made of an aluminum material since bus bar 400 is fixed to second electrode member 112b by welding. First electrode member 112a (a third metal layer) is made of copper so as to gain favorable electrical connection with the battery element (not illustrated) provided in battery cell 100.

As described above, negative electrode terminal 112 is provided so that first electrode member 112a and second electrode member 112b are integrated with each other, but an air layer A is slightly formed between first electrode member 112a and second electrode member 112b. Further, an organic substance P exists in this air layer A, inevitably. For convenience of explanation, air layer A and organic substance P are illustrated through enlargement of ratios regardless of their respective actual sizes.

In bus bar 400 and negative electrode terminal 112, the first metal layer, the second metal layer, and the third metal layer are arranged in this order from the upper side, and the first metal layer and the second metal layer are joined together by laser welding. The first metal layer and the second metal layer are made of a first metal material (aluminum) of an identical kind, and the third metal layer is made of a second metal material (copper) different from the first metal material.

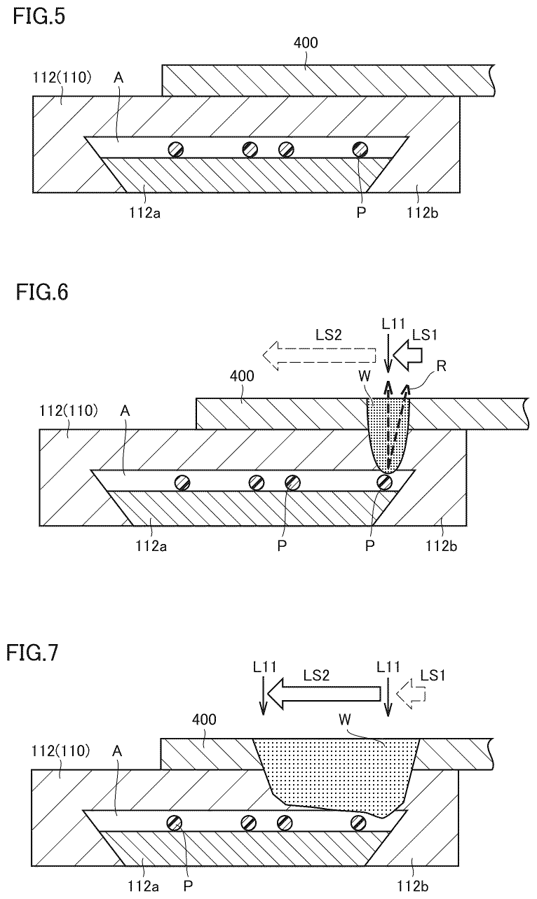

As illustrated in FIG. 6, bus bar 400 and second electrode member 112b are fixed by welding using laser light L11. In the present embodiment, bus bar 400 and second electrode member 112b are joined together by laser welding in which irradiation with laser light L11 is performed from the bus bar 400 side, and a scanning step of the laser welding includes a first scanning step LS1 and a second scanning step LS2 after first scanning step LS1. First scanning step LS1 includes a step of causing second electrode member 112b to be penetrated through by the irradiation with laser light L11, and second scanning step LS2 after first scanning step LS1 includes a step of not causing second electrode member 112b to be penetrated through by the irradiation with laser light L11.

It is meant here that the step of causing second electrode member 112b to be penetrated through by the irradiation with laser light L11 in first scanning step LS1 includes a step of causing second electrode member 112b to be penetrated through by intentionally controlling the irradiation with laser light L11. Thus, before and after the step of causing second electrode member 112b to be penetrated through, a step of not causing second electrode member 112b to be penetrated through may be included.

It is also meant that the step of not causing second electrode member 112b to be penetrated through by the irradiation with laser light L11 in second scanning step LS2 includes a step of not causing second electrode member 112b to be penetrated through by intentionally controlling the irradiation with laser light L11. Thus, before and after the step of not causing second electrode member 112b to be penetrated through, a step of causing second electrode member 112b to be penetrated through unintentionally (inevitably) may be included.

As illustrated in FIG. 6, first scanning step LS1 includes the step of causing second electrode member 112b to be penetrated through by controlling the irradiation with the laser light. Thus, at an initial stage, a molten pool W in the welding is formed so as to penetrate second electrode member 112b through, and accordingly, molten pool W reaches air layer A formed between first electrode member 112a and second electrode member 112b.

At this time, when air layer A is filled with the air expanded due to the heat of the laser light and the vaporized gas of organic substances P, the expanded air and the vaporized gas can be discharged to the outside in advance through a gap in the molten pool (see arrow R in FIG. 6).

After that, in second scanning step LS2 illustrated in FIG. 7, the welding step of not causing second electrode member 112b to be penetrated through by controlling the irradiation with laser light L11 is performed.

For the control of the irradiation with laser light L11 in first scanning step LS1 and second scanning step LS2, various control methods are conceivable. For example, a method can be employed, in which an output of laser light L11 in first scanning step LS1 is made larger than an output of laser light L11 in second scanning step LS2.

For example, when the thickness of bus bar 400 is approximately 0.5 to 1 mm, the thickness of first electrode member 112a is approximately 0.5 to 1 mm, and the thickness of second electrode member 112b is approximately 1 to 2 mm, in first scanning step LS1, the output of laser light L11 is 1800 W, the scanning speed is 400 mm/s, and the duration of the irradiation is 10 msec, and in second scanning step LS2, the output of laser light L11 is 1500 W, the scanning speed is 400 mm/s, and the duration of the irradiation is 10 msec.

Further, as another control method, a method can be employed, in which the duration of the irradiation with laser light L11 in first scanning step LS1 is made longer than the duration of the irradiation with laser light L11 in second scanning step LS2.

For example, when the thickness of bus bar 400 is approximately 0.5 to 1 mm, the thickness of first electrode member 112a is approximately 0.5 to 1 mm, and the thickness of second electrode member 112b is approximately 1 to 2 mm, in first scanning step LS1, the output of laser light L11 is 1500 W, the scanning speed is 200 mm/s, and the duration of the irradiation is 10 msec, and in second scanning step LS2, the output of laser light L11 is 1500 W, the scanning speed is 400 mm/s, and the duration of the irradiation is 20 msec.

As for the structure after the welding, as illustrated in FIG. 7, the employment of the welding method described above brings, when viewed in cross-section along the direction of the irradiation with laser light L11 after the laser welding, a cross-sectional structure where, in the weld of bus bar 400 and second electrode member 112b, the welding depth is made smaller in a central portion than in an outer portion, and the welding depth in the outer portion is large so that second electrode member 112b is penetrated through.

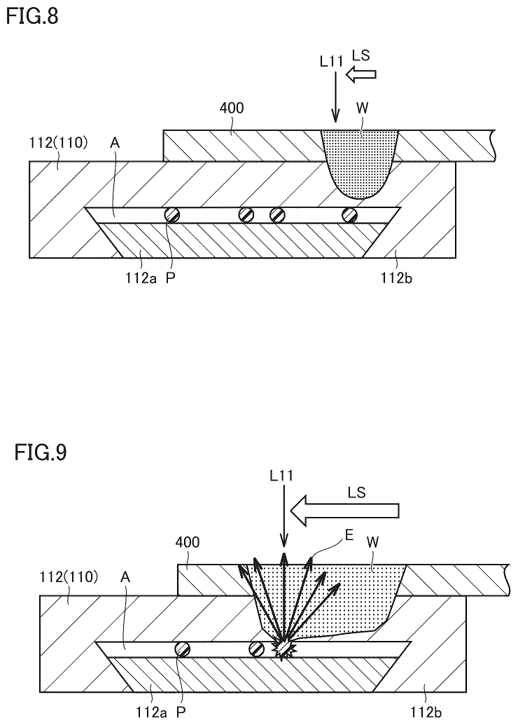

A structure according to related art is described with reference to FIGS. 8 and 9. FIGS. 8 and 9 illustrate a case where the output and the scanning speed of laser light L11 are constant when bus bar 400 is welded and fixed to second electrode member 112b. Although the output of laser light L11 is controlled so as not to cause second electrode member 112b to be penetrated through, heating is caused by the heat of the laser light, the heat is gradually accumulated, and the welding depth in the weld of bus bar 400 and second electrode member 112b gradually becomes larger.

Accordingly, the weld reaches air layer A in the middle of the scanning with laser light L11. Consequently, the pressure of the air that has expanded and the gas that has been vaporized in air layer A since the beginning of the welding is increased, and at the moment at which the weld reaches air layer A, the expanded air and the vaporized gas are ejected to the outside (see arrow E in FIG. 9).

As described above, by the welding method according to the present embodiment, it is enabled to release the expanded air and the vaporized gas present in air layer A to the outside at an initial stage and inhibit the ejection of the expanded air and the vaporized gas to the outside.

As a result, bus bar 400 can be favorably welded to electrode terminal 110 provided on battery cell 100 employed in battery assembly 1.

Although the case where bus bar 400 is welded to electrode terminal 110 provided on battery cell 100 is described above, the present disclosure is not limited to this application example but is applicable to a connection portion having a similar configuration.

Although the embodiments of the present disclosure have been described, it should be understood that the herein-disclosed embodiments are presented by way of illustration and example in all respects and are not to be taken by way of limitation. The scope of the present disclosure is defined by the claims and intended to include any changes within the purport and scope equivalent to the claims.

What is claimed is:

1. A welding method of joining a first metal layer and a second metal layer together by laser welding, the first metal layer, the second metal layer, and a third metal layer being arranged in this order from an upper side, wherein
the first metal layer and the second metal layer are made of a first metal material of an identical kind,
the third metal layer is made of a second metal material different from the first metal material, and
when irradiation and scanning with laser light are performed from a side of the first metal layer to join the first metal layer and the second metal layer together by the laser welding,
the scanning with the laser light includes a first scanning step and a second scanning step after the first scanning step,
the first scanning step includes a step of causing the second metal layer to be penetrated through by the irradiation with the laser light, and
the second scanning step includes a step of not causing the second metal layer to be penetrated through by the irradiation with the laser light.

2. The welding method according to claim 1, wherein an output of the laser light in the first scanning step is larger than an output of the laser light in the second scanning step.

3. The welding method according to claim 1, wherein duration of the irradiation with the laser light in the first scanning step is longer than duration of the irradiation with the laser light in the second scanning step.

4. The welding method according to claim 1, wherein
the first metal material is aluminum, and
the second metal material is copper.

5. The welding method according to claim 1, wherein
the first metal layer constitutes a bus bar used in a battery assembly,
the second metal layer and the third metal layer constitute an electrode terminal included in the battery assembly, and
the bus bar is welded to the electrode terminal using the laser light.

6. A welding structure comprising a first metal layer, a second metal layer, and a third metal layer arranged in this order from an upper side, the first metal layer and the second metal layer being joined together by laser welding, wherein
the first metal layer and the second metal layer are made of a first metal material of an identical kind,
the third metal layer is made of a second metal material different from the first metal material,
irradiation and scanning with laser light are performed from a side of the first metal layer to join the first metal layer and the second metal layer together by the laser welding, and
when viewed in cross-section along a direction of the irradiation with the laser light after the laser welding,
a welding depth of a weld between the first metal layer and the second metal layer is smaller in a central portion than in an outer portion, and
the welding depth in the outer portion is large so that the second metal layer is penetrated through.

7. The welding structure according to claim 6, wherein
the first metal material is aluminum, and
the second metal material is copper.

8. The welding structure according to claim 6, wherein
the first metal layer constitutes a bus bar used in a battery assembly, and
the second metal layer and the third metal layer constitute an electrode terminal included in the battery assembly.
